(19) United States
(12) Patent Application Publication
(10) Pub. No.: US 2021/0248527 A1
(43) Pub. Date: Aug. 12, 2021

(54) SYSTEM AND METHOD TO IDENTIFY RISKS AND PROVIDE STRATEGIES TO OVERCOME RISKS

(71) Applicant: Adapt Ready Inc., New York, NY (US)

(72) Inventors: Shruthi Nagaraja RAO, New York, NY (US); Sandeep Chandur RAVI, New York, NY (US)

(21) Appl. No.: 17/245,718

(22) Filed: Apr. 30, 2021

Related U.S. Application Data
(63) Continuation of application No. 14/886,104, filed on Oct. 19, 2015.

(51) Int. Cl. G06Q 10/06

(52) U.S. Cl. CPC G06Q 10/0635

(57) ABSTRACT

A system and method to identify risks and provide strategies to overcome risks. The system is configured to accumulate information corresponding to an entity and at least one sub-entity that operates in association with the entity, identify risks that are inferred to have an impact on the functioning of the entity, generate and communicate alerts to the entity specifying the risk and thereafter provide strategies to the entity to overcome impacts of the risks faced by the entity.

### RELATED APPLICATION

The present application claims priority to and the benefit of U.S. patent application Ser. No. 14/886,104, filed on Oct. 19, 2015, the disclosure of which is incorporated by reference herein in its entirety.

### BACKGROUND

Unless otherwise indicated herein, the materials described in this section are not prior art to the claims in this application and are not admitted to be prior art by inclusion in this section.

### Field

The subject matter relates to risk assessment and providing strategies to cope with, or adapt to the risks.

### Discussion of Related Art

There is always a need for business entities to plan and prepare strategies m advance to mitigate losses. There exist systems and methods for analyzing risks and providing business recommendations based on weather parameters or related risks. But there still exists a need, wherein technology may be utilized in integrating data from multiple sources to provide adaptation strategies for a broad range of the probabilities of external or internal changes.

There exist techniques that enable evaluation of risk by utilizing history of weather over a period of time. The techniques of weather risk assessment relates to accessing risk assessment of a specific business at a specific location due to changes in weather. The techniques involve enabling a user to provide business specific data by completing a questionnaire or answers to questions provided by the weather risk assessment engine. The instant technique specifically deals with assessment of risks related to changes in weather.

The technique fails to take into consideration risks which may arise out of factors other than weather, which may have an impact on the functioning of the entity.

Another prior art technique relates to forecasting of business performance taking into account data stored in sales history database, weather history databases and weather forecast databases. For example, for a specific location and period, the weather data comprises data such as, average temperatures in June, historical weather data such as, temperatures the past June, and forecast data such as, the temperatures next June. The historical weather data may cover data from the past two to five years or any other alternative time spans. The technique of the prior art may enable forecasting of retail performance of the products at the locations; however, the system fails to consider factors other than weather, which may impact business performance. Further, the technique fails to provide solutions to improve business performance based on the factors which may impact business.

Further, there are applications catering to mobile devices, which are intended for providing risk alerts to entities involved in agriculture. One such application makes use of GPS technology and provides forecasts and alerts related to weather risks. Any individual person or entity can create custom alerts for forecasted and observed weather conditions, precipitation amounts, dangerous storms, etc. by using the app. Interactive weather maps access comprehensive layered satellite maps, animated radar, future radar, storm corridors, temperature, dew point, humidity, wind direction, and precipitation amounts. The app can monitor multiple locations and a user can receive alerts for the location where an individual is working as well as other points of interest. The app is specially designed to help farmers monitor weather for their farms.

Another mobile application provides forecasts related to agriculture along with news on farming and professional agriculture. Other features of the app are its alert service based on user's preference for weather phenomena, and historical data presentation with a summary of the observed weather for the specified date.

The systems of the prior art are configured to provide risk assessment considering weather patterns and hence are able to predict risks which may occur in the near future such as up to 15 days. The systems are not configured to predict risks which may occur in the years to come. Further, the systems fail to provide ways to overcome a crisis or provide solutions, options or strategies to tackle the risks due to multiple factors, how alternate strategies could reduce, mitigate or even eliminate the risks, and analysis of each specific strategy and the corresponding reduction in risks. Also, the systems of the prior art do not combine the ability to work with short-term and long-term risks specific to a business and its locations.

In light of the foregoing discussion there is a need for a technique for providing adaptation strategies to the entities, considering factors which may impact their business performance in the years to come.

### SUMMARY

The present invention discloses a system and method to identify risks, provides strategies to overcome those risks, along with the necessary decision support systems. The system is configured to accumulate information corresponding to an entity and at least one sub-entity that operates in association with the entity, identify risks that are inferred to have an impact on the functioning of the entity, generate and communicate alerts to the entity specifying the risk and thereafter provide strategies to the entity to overcome impacts of the risks faced by the entity. Another embodiment of the present invention enables the entity to adjust a factor of risk for each of the risks faced by the entity, and thereafter, provide strategies to the entities to cope with the risk, based on the factor of risk.

The present invention discloses a system and method to identify risks and provide strategies to overcome risks. The system comprises a critical risk determination module configured to determine risks which are critical to the functioning of an entity, a risk assessment module configured to receive information corresponding to at least one entity and at least one or more sub-entity that operates in association with the entity and identify a plurality of risks that are inferred to have an impact on the performance of the entity by processing at least a portion of information received. The system further comprises an alerting module configured to generate alerts specifying the risk faced by the entity or sub- entity by processing at least a portion of information received by the risk assessment module and a strategy module configured to generate strategies to overcome risks faced by the entity and correlate strategies to risks faced by the entity.

The present invention discloses a method for identifying risks and providing strategies to overcome risks. The method comprises processing data from at least one or more entities and one or more sub entities that operate in association with the entities, identifying risks having an impact on the performance of the entities, alerting the entities of the risks faced by the entities and providing strategies to the entities to overcome the risks faced by the entities.

The present invention discloses a method for obtaining an insurance premium for an entity. The method comprises, determining a lower threshold capacity of the entity, determining a higher threshold capacity of the entity, determining if a risk is within the lower threshold capacity and the higher threshold capacity, determining an adaptive capacity of the entity and sharing the adaptive capacity, the lower threshold capacity and the higher threshold capacity to obtain an insurance premium for the entity.

### BRIEF DESCRIPTION OF DRAWINGS

Embodiments are illustrated by way of example and not limitation in the Figures of the accompanying drawings, in which like references indicate similar elements and in which:

FIG. 1 is a block diagram illustrating exemplary communication between a system and a plurality of entities, in accordance with an embodiment;

FIG. 2 illustrates network of entities as per geographical location and their exemplary communication with the system 100, in accordance with an embodiment;

FIG. 3 is a flowchart illustrating an exemplary method for listing risks which may affect the entity, in accordance with an embodiment;

FIG. 4 is a flowchart illustrating an exemplary method for determining risks which are critical to an entity, in accordance with an embodiment;

FIG. 5 is a flowchart illustrating an exemplary method for determining strategies to overcome risks faced by entities, in accordance with an embodiment;

FIG. 6 is a flowchart illustrating an exemplary method for assessing risk faced by entities, in accordance with an embodiment;

FIG. 7 is a flowchart illustrating an exemplary method for alerting entities of impending risks faced by the entities, in accordance with an embodiment;

FIG. 8 is a flowchart illustrating an exemplary method for providing strategies to the entities to overcome risks faced by the entities, in accordance with an embodiment;

FIG. 9 is a flowchart illustrating an exemplary method for identifying risks faced by entities, alerting the entity about the impending risk and thereafter providing strategies to entities for coping with risks, in accordance with an embodiment;

FIG. 10 is a flowchart illustrating an exemplary method for adjusting a risk factor pertaining to the risk faced by the entity, in accordance with an embodiment;

FIG. 11 illustrates an exemplary webpage displaying a risk map, in accordance with an embodiment; and

FIG. 12 illustrates an exemplary method for obtaining an optimal insurance premium for the entity, based on the entity's risk management initiatives, in accordance with an embodiment

### OVERVIEW

An embodiment provides a system for alerting one or more entities of any possible risks which may affect their business and, based on the risks, provides strategies to cope with the risks. The system may include a critical risk determination module, a risk assessment module, an alerting module, a strategy module and a risk factor adjustment module. The system may also include a database. Alternatively, the system may have access to the database or a network of databases or other disparate sources of data which may be located in a remote location, connected over an appropriate network protocol. Additional sources of risk data could include a web-based application programming interface (API) end-point from a third-party service, a flat file (which could be structured, such as XML), and even unstructured data files such as, news reports, annual reports, sustainability reports among others. The critical risk assessment module may be configured to determine the risks which are critical to the business of the entity. The risk assessment module may be configured to access the critical risk assessment module and thereafter determine if there are any risks which may affect the business, i.e. in terms of revenue, business disruption, employee and customer impact, of the entities. The alerting module may be configured to issue alerts to the entities informing the entities of the impending risks faced by the entities. The strategy module may be configured to communicate with the database, risk assessment module and the alerting module and thereafter determine strategies to overcome impending risks and communicate the strategies to the entities. The risk factor adjustment module may be included in the system to enable the entities to input a value to the risk factor on the risks faced by the entities. The value of the risk factor may have an impact on the strategies suggested to overcome the risks. Conversely, selecting specific strategies suggested by the system may have an impact on the risk factor.

The following detailed description includes references to the accompanying drawings, which form a part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiment can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### EXEMPLARY SYSTEM

The system 100 may include a database 102. Alternatively, the system 100 may have access to a database 102, which may be located in a remote location, through a wired or wireless connection. The database 102 may include data pertaining to but not limited to entitles and its sub entities, list of risks which may affect the business of the entity and its sub entities, historical data pertaining to risks faced by entities, listing of strategies adopted or implemented to overcome corresponding risks, historic data pertaining to strategies adopted or implemented as per geographical location to overcome risks, historical data pertaining to strategies adopted or implemented by specific industries to overcome risks, historical data pertaining to strategies adopted or implemented by specific entity to overcome risks, historic weather data, weather forecast data, climate forecast data, political reporting data, economic reporting data and entity internal status report data or other data. The entity can be a corporation, a multinational company, a LLC, a LLP, partnership, city government, state government, federal government, school, hospital, and dependents of such an entity, including, but not limited to, its suppliers, vendors, warehouses, and so on.

The system 100 further includes a critical risk factor determination module 104, a risk assessment module 106, an alerting module 108, a strategy module 110 and a risk factor adjustment module 112. The critical risk assessment module 104 may be configured to determine risks which may be critical to the business of the entity and its sub entities. The critical risk assessment module 104 may have access to the database 102, where listing of risks pertaining to industry type and geographical location of the entity, among other risks may be stored. The critical risk assessment module 104 may process the data stored in database 102 pertaining to critical risks corresponding to the entity and its sub entities and determine which risks may be critical to the business of the entity.

An algorithm (or a group of algorithms) may be included in the critical risk assessment module 104 to process the data and determine risks critical to the entity. The risk assessment module 106 may be configured to determine the risks faced by entities, including any critical risks. The risk assessment module 106 may have access to, but is not limited to, the database 102 and the alerting module 108. The risk assessment module 106 may be configured to monitor data pertaining to all risks which may be faced by the entity, and when the level of risk goes above a predetermined value, the risk assessment module 106 may determine that, there are impending risks faced by the entity. An algorithm may be included in the risk assessment module 106 to process data and determine if there are impending risks, including any critical risks, faced by the entity.

The risk assessment module 106 may be further configured to access impending risks faced by the main entity and the sub entity and thereafter determine if there are any impending risks faced by the main entity. The alerting module 108 may have access to but not limited to the risk assessment module 106, the database 102, the strategy module 110 and the risk factor adjustment module 112. The alerting module 108 may be configured to issue alerts to the entities, alerting the entities of impending risks. The alerting module 108 may be configured to issue alerts to the entities through one or more of email, desktop and web application alerts, cellular phone alerts and alerts through mobile applications, among other alerting channels.

The alerting module 108 may be configured to communicate alerts and strategies to the entities in a predetermined time frame or when there is an urgent alerts. to be communicated to the entities. The time frame of receiving alerts can be set by the entities. For example, the entity can set the time frame as receiving weekly alerts, monthly alerts or alerts only when there is an impending risk.

The alerting module 108 may be further configured to determine if the entity has acknowledged the receipt of the alert. if any entity has not acknowledged the receipt of the alert, the alerting module 108 can be configured to resend the alert to the entity until an acknowledgment is received by the entity. The time frame for resending alerts may be configured. The risk factor adjustment module 112 may be an optional module included in the system 100 to enable the entities to adjust the risk factor on the risks faced by the entities.

The risk factor adjustment module 112 may be configured to provide an option to the entities to adjust the factor of risk The adjustment of risk factor may be an action of assigning a value or degree of probability to the risk. For example, a higher assigned value to the risk may mean that, the risk is of more importance compared to a risk assigned a lower value. The strategies to cope with the risk may change with the value assigned to the risk. The risk factor adjustment module 112 may have access to but not limited to the risk assessment module 106, the database 102, the alerting module 108 and the strategy module 110. The alerts and strategies issued to the entities may have a direct correlation to the factor of risk on the risk factor adjustment module 112.

### EXEMPLARY COMMUNICATION BETWEEN SYSTEM AND ENTITIES

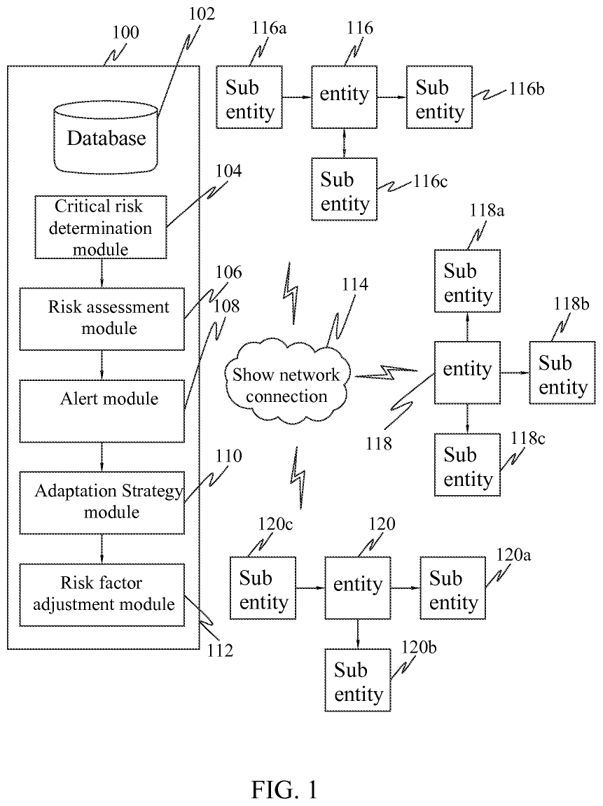

FIG. 1 is a block diagram illustrating exemplary communication between a system 100 and a plurality of entities. The system 100 may be configured to communicate with a plurality of entities and their sub entities through a network 114. The network 114 may be an internet network, a wireless network, a wired network and a LAN network among other networks configured to facilitate communication. The system 100 may include software to enable communications over the network such as HTTP, TCP/IP protocols etc. In alternative embodiments of the present invention, other communication software and transfer protocols may also be used, for example IPX, UDP or the like. The main entities can be for example illustrated by entities 116, 118 and 120. The main entities 116 may have sub entities such as, 116a, 116b, 116c, 118a, 118b, 118c, 120a, 120b, 120c. The entities 116, 118 and 120 may have its sub-entities such as manufacturing plants, suppliers and vendors, among others. The main entities can be in communication with their sub entities and vice versa. The data pertaining to the sub entity which may be relevant to the business of the main entity may be communicated to the main entity, sub entity, or both the main entity and sub entity. Further all data which may relate to the risks faced by the sub entity to the sub entity's business may be communicated to the mam entity. The mam entity may have sub entities m multiple locations. The main entity may receive data from all its sub entities. Upon receiving such data, the main entity may communicate such data to the system 100 for processing. The system 100 may receive data from multiple entities. Upon receiving the data, the system 100 may store the data in the database 102 and process the data to communicate relevant information to the entities. The information communicated from the system 100 to the entities may be alerts relating to risks and strategies for overcoming risks. The information may be communicated from the system 100 to the main entity. Further, the information may be communicated from the system 100 to the sub entities as well, based on the predetermined options chosen by the entities.

### EXEMPLARY ENTITY NETWORK

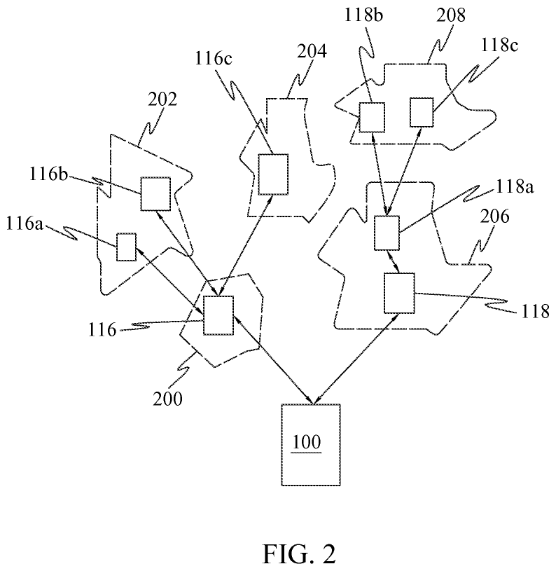

FIG. 2 illustrates a network of entities as per geographical location and their exemplary communication with the system 100, in accordance with an embodiment. For example, the entities 116 and 118 may be located in geographical locations 200 and 206 respectively. The main entities 116 and 118 may have sub entities which may be manufacturing plants of the main entity at different locations, suppliers, vendors and contactors among others. For example, the sub entities 116a, 116b and 116c of the main entity 116 may be located in a different geographical location 202 and 204 from the location 200 of the main entity. The risks faced by the sub entities may be different, owing to their different geographical locations. The risks impacting the entities and their business may be due to change in weather, climatic aberrations, natural disasters or any external possibility fix example, predictable, unpredictable environmental aberrations, natural or man-made disasters, economic and political changes, among other factors. The risks faced by the main entity and their corresponding sub entities may differ based on different factors affecting the entities owing to their geographical location. The system 100 may be configured in such a way as to identify a location of each of the entities and sub-entities, analyze their interdependence, analyze impact of external and internal factors on them and generate risk reports and risk projections for each of them individually and independently. Multiple sources may transmit data and information related to the entity, its locations and its associations to the system 100. For example, the geographical region 202 may suffer issues related to weather and climate such as snow, thunderstorms and heat wave, among others. Similarly, the geographical region 204 may suffer issues related to political instability, war and economic instability, among others. In such cases, the risks faced by the entities and their implications differ. Further, the same risk event may have a different impact on different entities; for example, in geographical region 202, sub-entities 116a and 116b may be exposed to the same flood event, however, owing to the fact that sub-entity 116a is at a higher elevation than sub-entity 116b, the risk factor for 116a is lower. Furthermore, the same risk event may have a different level of risk impact on two different entities or sub-entitles based on their specific function; for example, a cotton farmer may benefit from increased precipitation events and thereby have a low risk factor, but another entity in the same region, in a low-lying region, may be subject to flood risks and thereby have a high risk factor.

### EXEMPLARY METHOD FOR LISTING RISKS

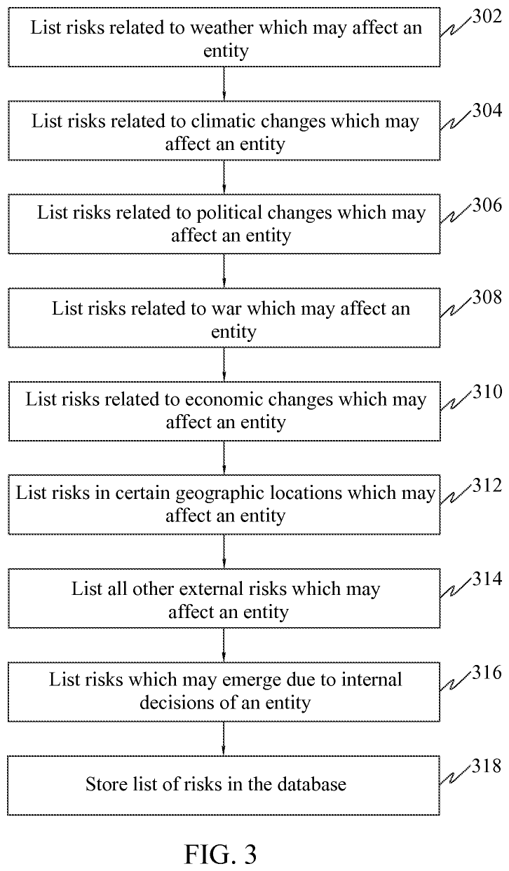

FIG. 3 is a flowchart illustrating an exemplary method for listing risks which may affect the entity, in accordance with an embodiment. At step 302, weather related risks which may affect the business of entities may be listed. For example weather related risks may be risks which may arise out of change in weather such as, heavy rains, heavy snowfall, floods, blizzards, hurricanes, tornado, storms and cyclones, among other factors. There may be multiple consequences which may arise out of weather factors, these may relate to transportation and storage of material, transportation of employees to their work location, destruction of property, destruction of raw material, loss of goods, spoilage of goods, stoppage of work and reduction of production, among other consequences. At this step 302, all weather related risks which may have an impact on the business of the entities may be listed. This list may be prepared based on historical data and experience of a risk manager. The risk manager may be a human risk manager or a computer based risk manager. A human risk manager may be able to prepare a list of risk based on his experience as a risk manager. A computer based risk manager may be programmed to list risks which may be faced by entities. The computer based risk manager may be developed based on the experience of the human risk managers.

At step 304, climate related risks which may affect the business of the entities may be listed. For example climate related risks may be long term climatic changes such as global warming, changing of temperature, changing of weather patterns, changing of ecosystems, rising sea levels, changing landscapes, increased risk of drought, decreasing ground water levels, increased risk of fire and increase risk of floods, among others. At step 304, the risks arising out of such climatic changes are listed. These risks arising out of climatic changes may have a long term impact and may affect the business of the entities in the long term.

At step 306, all political related risks which may have an impact on the business of the entities may be listed. The list may be prepared based on historical data and experience of the risk manager, For example political related risks may be related to, type of government at the geographical location, political instability, attitude of the government towards entities or an entity's government, policies and regulations of the government and decision making ability of the government, among others. The risks which may arise out of political changes or political factors may be listed. The consequences of risks arising out of political factors may have an impact on the business of the entities.

At step 308, risks which may arise out of war, influx of refugees, acts of violence, acts of terrorism and kidnapping among other such acts, which may have an impact on the businesses of the entities, may be listed. There may be consequences of such acts in the location or neighboring locations of the entity. These consequences may in the form of unavailability of raw material, transportation of goods, scarcity of fuel, inability to operate the entity, unavailability of employees and danger and destruction of property, among others. The list of risks arising out of war may be made based on historical data and experience.

At step 310, risks which may arise out of economic changes or factors may be listed. For example economy related risks may be risks which may arise out of economic changes such as, bankruptcy of an entity, fall of share prices, increase in prices of raw material, increase in price of fuel and economic policies of government, among other economic factors. The risks which may arise due to such exemplary factors may be listed at step 310. The risks may be computed based on historical data as well as knowledge of an economic advisor. The economic advisor may be a human economic advisor or a computer based economic advisor. A human economic advisor may be able to prepare a list of risk based on his experience as an economic advisor. A computer based economic advisor may be programmed to list risks which may be faced by entities. The computer based risk manager may be developed based on the experience of the human economic advisors.

At step 312, risks which may relate to the geographical location of the entity may be listed. For example geographical location based risks may be risks such as earthquake prone area, area prone to volcanic eruptions, area prone to floods, area prone to fires, area prone to hurricanes, area prone to cyclones and area prone to tsunami, among others. There may arise risks which may be due to the location of the entity in such areas and may pose risk to the business of the entity, upon occurrence of any calamity in the geographical locations. At step 314, all other risks which may have not been listed in the previous steps, which may have an impact on the business of the entity may be listed. At step 316 risks which may emerge due to internal decisions of the entity may be listed. Such a list can be made based on historical data. For example, such risks may be worker strike at the entity, demand of excess wages by the employees, employee attrition, law suits, accidents, management failure and bad decisions, among other such factors. At step 317, risks related to impact on health due to climate change may be listed. At step 318, all the listed risks may be stored in the database 102 and any new risk may be added to the existing repository of risks.

### EXEMPLARY METHOD FOR DETERMINING CRITICAL RISKS

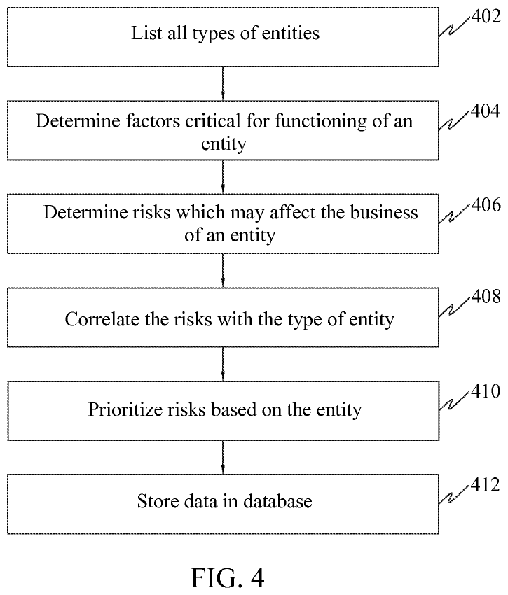

FIG. 4 is a flowchart illustrating an exemplary method for determining risks which are critical to an entity, in accordance with an embodiment The list of risks which may be listed by the method illustrated in FIG. 3, may be accessed by the system 100 to determine critical risks as well. Among the list of risks obtained by the method illustrated in FIG. 3, the critical risks pertaining to the entity may also be determined.

At step 402, a listing of types of entities may be carried out The entities may be listed based on nature of business of the entities. For example, an entity may be in the business of manufacturing cars, another entity may be in the business of selling hardware material and another entity may be in the business of running restaurants. Such a listing of all types of businesses may be created at step 402.

At step 404, for all the listed entities, factors which may be critical for functioning of the entity may be determined. For example, for an entity involved in making olive oil, the main factor for the functioning of the entity may be the availability of olives, or availability of adequate rainfall at the location where olives are sourced from. Similarly for an entity involved in the manufacturing of leather shoes, the main factor for the functioning of the entity may be availability of leather, followed by skilled workers to manufacture shoes. Similarly, for all the listed entities, the factors which may critical for their business may be determined at step 404.

At step 406, the risks which may affect the business of the entity may be determined. Risks may depend on the business of the entity and different risks may affect different entities. For example, for an entity involved in the manufacturing of olive oil, risks which may affect them may be rains, drought, diseases to plants, which may lead to shortage of olives, thereby affecting production and business. All risks which may have an effect on the business of the entity may be listed at step 406. At step 408, the listed risks may be correlated with the type of entity. There may be risks which are specific to industry or entity type. Risks are categorized on a per-industry and per-entity type basis.

At step 410 priorities may be assigned to the listed risks. All risks may not be critical. Some risks would be more critical than others. The prioritizing of risks may enable the entities to focus more 011 the risks which would have more impact 011 their business and strategize to overcome those risks. The prioritizing of risks may be carried out by the risk manager, who may determine which risks carry higher priority compared to other risks. The risk manager may be a human risk manager or a computer based risk manager who may learn to prioritize risks fix corresponding entities, based on historical prioritizing, to which the system may have access.

At step 412, all the data relating to priority assigned to risks, risks critical to the entity and correlating of the risks to the industry, may be stored in the database 102. Further, the risks critical to the functioning of the entity may change over time. The critical risk determination module 104 may be configured to determine and change the critical risks affecting an entity, as and when there is a change in the critical risks affecting the entity. The critical risks may change due to various factors such as, but not limiting to, obsoleteness of a risk due to time, change in factors affecting the entity, change in business interests of the entity and change in sub-entities of the main entity, among others. The change in critical risks affecting the entity may also change the strategies to be adopted by the entity to overcome the risks. The critical risk determination module 104 may be further configured to dynamically determine the critical risks faced by the entity and thereupon update the database 102. The terminology of critical risks may pertain to risks which may be faced by the entity, but may not be the only factor in determining the strategies for overcoming risks.

The system 100 may be configured to determine if a certain critical risk has to be considered in determining strategies to overcome risks. In some embodiments, the critical risks faced by the entity may not be determined and the strategies may be generated to overcome other risks faced by the entity. The other risks may be risks which may or may not have been listed. Certain risks may arise without them being listed before. In such scenarios, the criticality of the risk may be determined by the system 100 and strategies generated to overcome them.

### EXEMPLARY METHOD FOR DETERMINING STRATEGIES

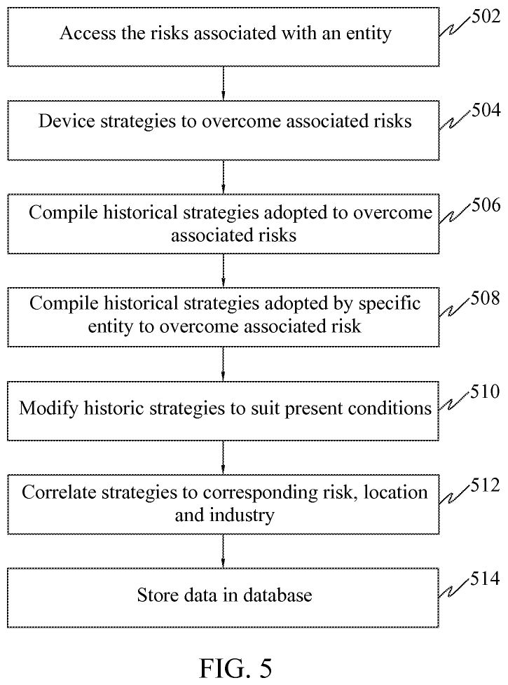

FIG. 5 is a flowchart illustrating an exemplary method for determining strategies to overcome risks faced by entities, in accordance with an embodiment. The method of determining risks faced by entities is illustrated in FIG. 3 and FIG. 4. The risks determined by these methods may be made available to the adaptation strategy module 110 by the database 102, wherein the list of risks is stored.

At step 502, the data relating to risks faced by entities are accessed. The data relating to all kinds of risks faced by entities may be present in the database 102. At step 504, strategies to overcome scenarios arising out of the listed risks may be accessed. The strategies to overcome risks may be devised by risk managers who can devise strategies to overcome situations arising out of corresponding risks.

At step 506, strategies which may have been historically adopted to overcome situations arising out of risks faced by entities may be listed. Implementing strategies which may have been historically implemented to overcome risks may be useful to the entities to decide on the right kind of adaptation strategy. Further at step 506, strategies which may have been historically implemented in the geographical location of the entity may be listed. Some strategies may be relevant to geographical locations and implementing such strategies by the entity may enable the entity to overcome the adverse situations arising out of the risk faced by the entity. Furthermore at step 506, strategies which may have been historically adopted by the specific industry to overcome adverse situations arising out of risks facing the industry may also be listed. The strategies may be related to the industry in general, Such strategies may have been developed considering historic data.

At step 508, strategies which may have been historically adopted by the specific entity or another entity of the same type, or another entity in the same industry to overcome adverse situations arising out of risks faced by the entity may be listed. The strategies listed at step 508 may be such strategies, which may have been adopted by the specific entity historically to overcome the instant risk.

At step 510, the listed strategies may be modified to suit present situations. Strategies which may have been adopted historically, may not be suitable for present situations. In such cases, the strategies may be modified to suit present conditions and situations. The strategies may be reviewed by risk managers from time to time to determine the suitability of the strategies to the present period. If the risk manager determines that the strategies suit the present time period, the strategies are not modified. However, if the risk manager determines that the listed strategy does not suit the present time period, the risk manager may modify the strategies to suit the present time period.

At step 512, all the listed strategies may be correlated to the corresponding risk, location, industry and entity. The correlation of strategies to associated risk can be for example, the strategy of increasing budget for irrigation water may be associated with the risk of drought and not due to risk arising out of transportation strike. Such correlation of strategies with associated risk can be carried out by human or computer based risk managers.

At step 514, all the compiled data may be stored in the database 102. The historical strategies can be compiled by risk managers by studying historical strategies adopted for overcoming risk and thereafter correlating strategies with associated risks. The historically adopted strategies may be found in databases which may list the strategies. The historical strategies adopted by entities may be found in records maintained by the entities relating to strategies adopted by the entity to overcome correlating risk The historical strategies adopted by geographical locations to overcome risks faced by entities owing to their location in the geographical location may be found in records maintained by administration or historians in the geographical location.

### EXEMPLARY METHOD FOR ACCESSING RISK

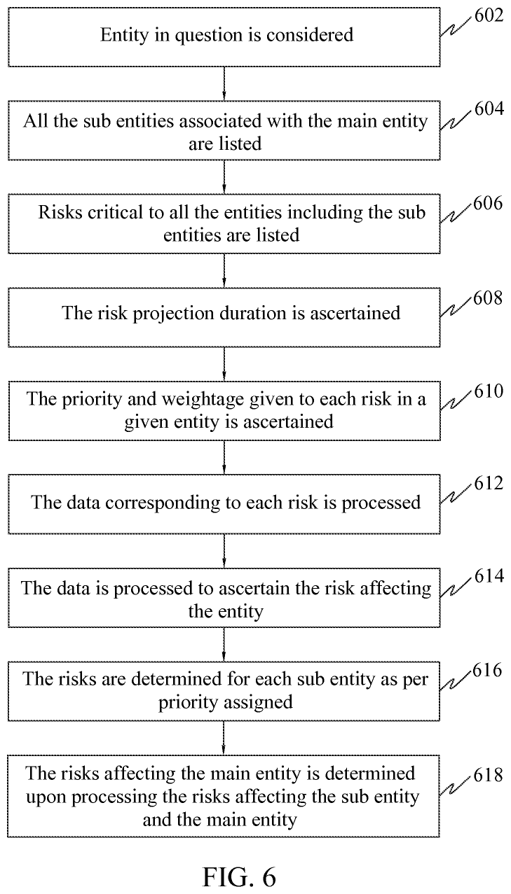

FIG. 6 is a flowchart illustrating an exemplary method for assessing risk faced by entities, in accordance with an embodiment. At step 602, the entity for whom risk assessment has to be carried out may be chosen. At step 604, the sub entities associated with the main entity may be listed, The main entity may have multiple sub entities located at different geographical locations and having different businesses or operations. All entities that may be connected with the business of the main entity may be considered as the sub entity of the main entity. For example, for the main entity located at a particular geographical location, engaged in a particular business, there may be sub entities, who may be located at different geographical locations, who may be vendors to the main entity, suppliers of raw material to the main entity, supplier of parts to the main entity, corporate offices of the main entity, subsidiaries of the main entity and manufacturing units of the main entity, among others, At step 606, the risks which the entity and the sub entities may face may be listed. The list of risks faced by all the entities associated with the main entity may be listed. The method of listing of the risks has been illustrated in FIG. 3. The list of risks listed as per the method illustrated in FIG. 3 can be listed in step 606. At step 608, the option chosen by the entity for the duration of risk projection may be ascertained. The entity may for example have chosen the duration of an hour to 20 years, such as 1 month, 6 months, 1 year, 5 years or 20 years.

In an exemplary method of projecting risk for a future duration of time, the following method may be used to project risks at different time-frames: “T” can be the set of training data, which corresponds to historical weather related extreme events for a period of last 50 years or more. Cₚₐₛₜ can be a set of historical climate models generated for the same time-frame. From the set C, using available statistical downscaling methods and other suitable methods a model to study the correlation of a given climate model to the training data can be built. The system 100 may be trained with this historical data by conducting posterior analysis by applying the same with climate projections from C_{future} which may be a set of climate models generated into the future. Available methods to conduct such posterior analysis include, but are not limited to, Monte Carlo simulations, Markov chain Monte Carlo among others. Based on the expected weather patterns, sensitivity analysis can be conducted for the time-frames chosen by the entity.

At step 610, a priority rating assigned to each of the risk associated with the entity may be ascertained. The priority rating assigned to the risk may be the rating assigned to the risk to determine which risk may be considered as more significant than other risks. At step 612, the data corresponding to each risk may be ascertained. The data corresponding to risks may be, for example, data pertaining to weather data, climate data, political data, economic data, the entity's internal data and any other data to ascertain risk. There may be numerous data included in the database 102, which may provide information pertaining to each of the risk associated with the entities. These data may be procured in real time and updated in the database 102. For example, data pertaining to weather may be data relating to temperature, rains, snowing and fog, among others. At step 614, the data corresponding to each of the risks may be processed to determine the risk affecting the main entity. The risk affecting the main entity may be determined by processing the data and determining if there is impending risk to the main entity. If a value in the data is higher than normal, it is determined that, there is risk The intensity of risk may be proportional to the deviation of the value from the normal value.

For example if weather forecast is for 300 mm of rain on day X, and the normal value of rainfall is 50 mm, then there is an excess of 250 mm of rain. This may be interpreted as a risk and strategies to overcome it may be devised. Further, if excess rainfall is 50 mm compared to 250 mm, the strategies to be selected may be different. The system 100 may have algorithms or access to a source of data (including, but not limited to, a database, network resource, data from a third party such as an actuary, and so on) incorporated to determine the intensity of the risk.

The time frame for prediction of risk may be based on the option chosen by the entity. For example one entity may choose the prediction term as 5 years, compared to another entity that chooses the prediction term as 25 years. At step 616, the data corresponding to each of the risks may be processed to determine the risk affecting the sub entitles of the main entity. The risk affecting the sub entities may be determined by processing the data and determining if there is impending risk to the sub entity. If a value in the data is higher than normal, it ls determined that, there is risk. The intensity of risk may be proportional to the deviation of the value from the normal value. For example if weather forecast if for 300 mm of rain on day X, and the normal value of rainfall ls 50 mm, then there ls an excess of 250 mm of rain. This may be interpreted as a risk and strategies to overcome it may be devised. Further, if excess rainfall is 50 mm compared to 250 mm, the strategies adopted may be different. The system 100 may have algorithms incorporated to determine the intensity of the risk. At step 618, upon determining all the risks affecting the main entity and the sub entities, the processed data is further processed as per the preconfigured logic to determine the risk affecting the main entity. The logic may determine which of the risks affecting the sub entities and the main entity would have an impact on the business of the main entity and thereupon determine the most significant risks which may affect the entity.

The pre-configured logic which may be incorporated in the system 100 may be based on the general operating procedures and business decisions of the entity. The logic may be updated as and when there may be a change is operating procedures and business decisions taken by the entity or whenever there may be need to change the logic. As an example, a main entity may have any number of sub entities that the main entity depends on for its business. A method to determine the risk affecting the main entity may be defined as follows. Cp may be a set of climate parameters that are pertinent to determine the risk for a given entity. Climate parameters may include, but are not limited to, temperature, precipitation, snowfall, sea level, drying trend (drought), ocean acidification, and other such climate-related drivers of impact, and any combinations and variations thereof Not all parameters may be responsible for the calculation of a numerical risk score. The system may be configured to consider the most important parameters that could cause a risk. This may be enabled by accessing and processing the information determined by the critical risk factor determination module 104. For example, a cotton growing farm may be at risk from a drought scenario in the specific cotton growing region. In another example, an entity may manufacture consumer products. Such an entity may have their products pass through different points in a value chain, which may be other entities or sub entities at different times and different geographical regions, each with its own unique climate-related numerical risk score. A value function such as, but not limited to, the sum of all numerical risk scores along the value chain traced by the item determines the overall risk score for that path along the value chain.

### EXEMPLARY METHOD FOR ALERTING ENTITIES

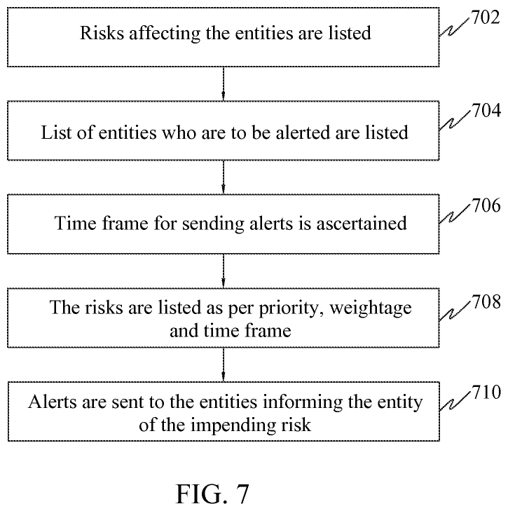

FIG. 7 is a flowchart illustrating an exemplary method for alerting entitles of impending risks faced by the entities, in accordance with an embodiment. At step 702, the risks affecting the entities which may be determined by the method illustrated in FIG. 6 may be listed. Upon listing the risks which may affect the entities, at step 704, the entities that are to be alerted of the impending risks are listed. The entities who are to be alerted may only be the main entity or may include the sub entities as well. The option of which entities may be alerted may be chosen by the main entity. At step 706, the time frame of communicating alerts to the entities may be ascertained. The time frame of communicating alerts may be chosen by the entitles. At step 708, the risks may be listed as per priority and time period. The list of risks to be communicated to the entity may consider both priority of the risk and the time period. Time period may be as to when the impending risk may affect the entity. If there are multiple risks with the same priority, which may be due in different time periods for example, 1 month, 6 months, 1 year, the risk which may affect the entity first may be listed at a higher order. At step 710, the alert may be communicated to the entitles, informing the entities of the impending risks.

### EXEMPLARY METHOD FOR PROVIDING STRATEGIES TO ENTITIES

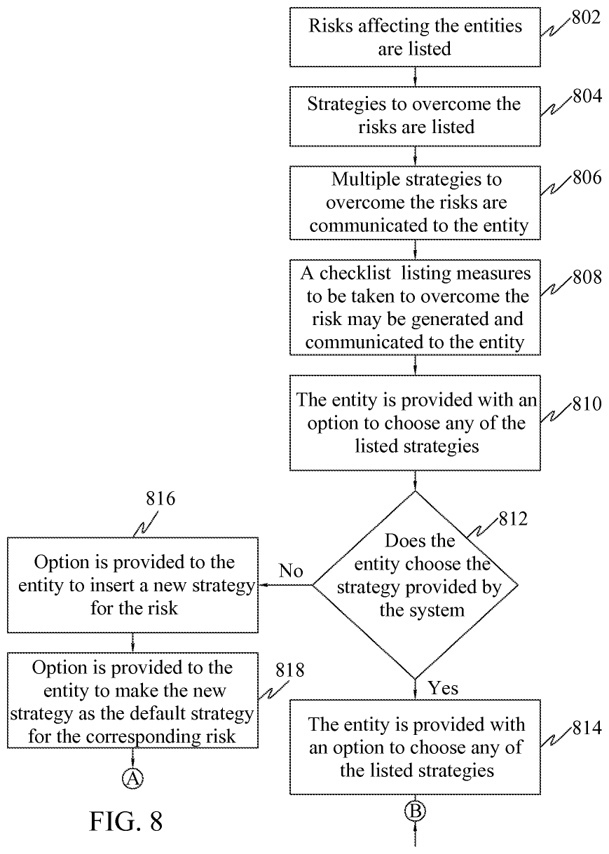

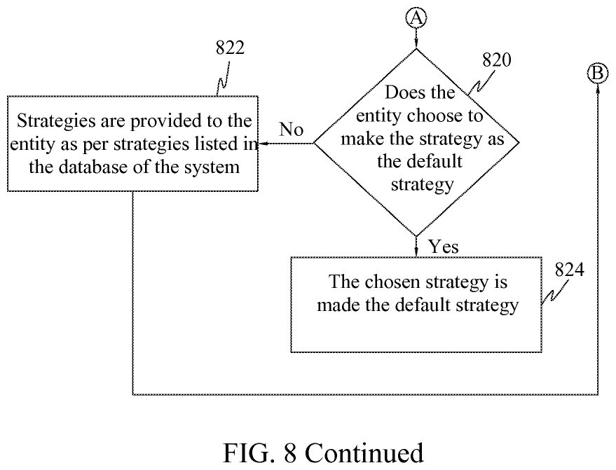

FIG. 8 is a flowchart illustrating an exemplary method for providing strategies to the entities to overcome risks faced by the entities, in accordance with an embodiment. At step 802, the risk affecting the entities may be listed. The list of risks may be procured by the method illustrated in FIG. 6. At step 804, the strategies to overcome the adverse situations arising out of the risks may be listed. At step 806, the strategies to overcome risks may be communicated to the entities. The strategies provided to the entities may be multiple strategies. At step 808, a check list which may list measures to overcome the impending risks may be generated and communicated to the entity. The check list may include a list of measures, which may be carried out to overcome risks. Upon accessing the check list, the entity may check which of the measures are carried out and which of them may be pending and thereafter take action. At step 810, the entity may be provided to choose any of the listed strategies to overcome risk. if at step 812, the entity chooses any of the listed strategies, then at step 814, the entity is provided with an option to choose any of the listed strategies. However, if at step 812, the entity does not choose the listed strategy to overcome the risk, then at step 816, an option may be provided to the entity to provide a new strategy to overcome the risk. Upon inserting the new strategy by the entity, at step 818, an option may be provided to the entity to make the inserted strategy as the default strategy for the specific entity for overcoming the risk. At step 820, if the entity chooses to make the inserted strategy as the default strategy, then at step 824, the strategy is made the default strategy and at step 816, the inserted strategy may be adopted by the entity to overcome the risk. However, at step 820, if the entity does not choose to make the strategy as the default strategy, then at step 822, strategies are provided to the entity as per strategies listed in the database of the system. The chosen strategy may be adopted to overcome the impending risk.

### EXEMPLARY METHOD FOR FUNCTIONING OF SYSTEM

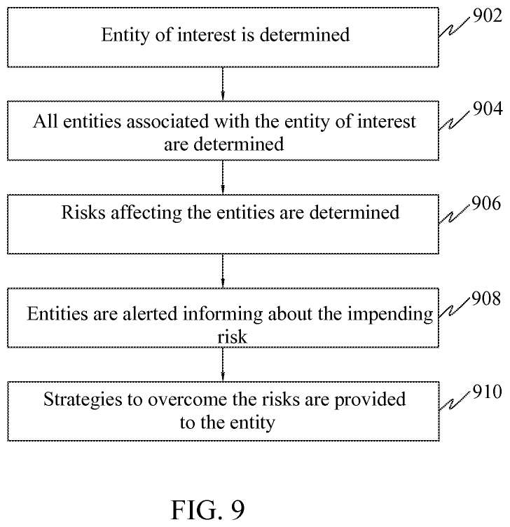

FIG. 9 is a flowchart illustrating an exemplary method for identifying risks faced by entities, alerting the entity about the impending risk and thereafter providing strategies to entities for coping with risks, in accordance with an embodiment. At step 902, the entity for whom the risk has to be accessed may be determined. At step 904, all the sub entities that may be associated with the main entity may be determined. At step 906, the risks which may affect the business of the entities may be determined. At step 908, the entities may be alerted of the impending risk. At step 910, strategies may be overcome the impending risks may be provided to the entity. A system 100 may be configured in such a way to identify operations of each of the entities and sub-entities, analyze impact of external and internal factors on them and generate risk reports and risk projections for each of them individually and independently. Multiple sources may transmit data and information related to the entity, locations and its associations to the system 100. Data and information relating to the entity and its sub-entities, their locations, and operations among other things may be transmitted to the system 100. The system 100 may comprise of modules wherein instructions execute the input data at levels, and may be connected to backend systems, supplier relationship management systems, enterprise resource planning systems, vendor management systems, product lifecycle systems, business management systems, supply sources and manufacturing plants among others. For example, a textile company may get a supply of raw material, such as cotton, and may store it in a warehouse in another region. The business of a textile company may suffer because of cases such as excess rainfall and subsequent damage to the crops, or political disputes leading to disruption in the supply of the raw materials. A flood-hit, unseasonal rain or snowfall, or storm may affect fanning, production, raw goods in manufacturing plants and delay the shipment Unpredictable political unrest or social chaos leading to transport problems may further cause disturbance in the supply chain. Reduction in production and further following the failure of insurance policies may add up to losses, disrupt economy and cause adverse effects on shareholders. For a particular region and entity or sub-entity, climatic changes tracked in the history and database, present status of the regions, their individual locations and operations may be used in assessing risks, developing solutions to combat crises and also prepare the entity in advance before any adverse situation arises due to the risks.

Information corresponding to each of the plurality of entities may be gathered and communicated via the network to the system 100. Information may include geographical data, environmental information etc. and internal information of the business entity. The inputs from database may be information about location, operation of entities, reliance on the vendors and suppliers, inventory etc. The risk assessment module 104 may determine the entity's capacity to adapt during risks, for the present state as well as for the future. The risk assessment module 104 may receive data relating to the risks faced by the entity over a period of time. The risk assessment module 104 may also receive data relating to the strategies adopted by the entity to overcome the impending risk. Upon processing such data, the risk assessment module 104 may be configured to assess the capacity of the entity to adapt to risks. For example, if the strategies adopted by the entity to overcome the risks are not adequate, the risk assessment module 104 may determine that, the entity has !ow capacity to adapt to risks. However, on the other hand, if the strategies adopted by the entity to overcome risks are adequate, the risk assessment module 104 may determine that, the entity has adequate or high capacity to adapt to risks. The historical records, real-time data and forecast references may be taken from heterogeneous sources for a broad scope analysis. The parameters for risk analysis may not be limited to nature's conditions but can extend to impact on business because of other external risks as well. Risk assessment module 104 reads historical records, real-time data and forecast references of each of the factors (influencing the entities directly or indirectly) from the database 102. All inputs may be processed by the risk assessment module 104 to generate risk reports and demonstrate risk projections for the coming years or even days. Risk reports may be demonstrated through graphs, spreadsheets, or any other communication methods, reports, or displays. On the basis of these reports, present and future adaptive capacities of the entity may be calculated.

### EXEMPLARY METHOD FOR ADJUSTING RISK FACTOR

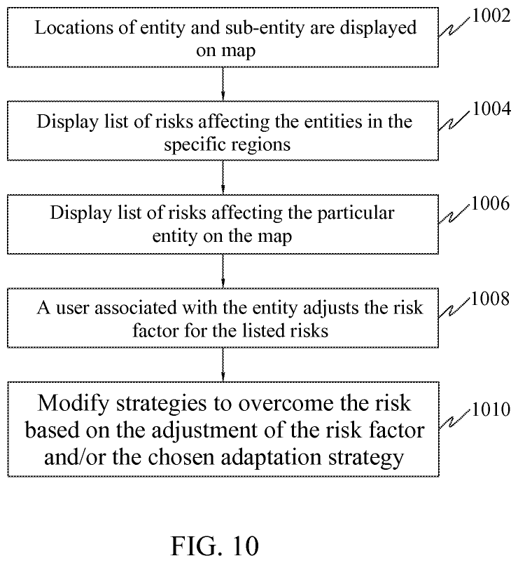

FIG. 10 is a flowchart illustrating an exemplary method for adjusting a risk factor pertaining to the risk faced by the entity, in accordance with an embodiment. At step 1002, on a webpage, the locations of the entity and its corresponding sub entities may be displayed on a map depicting geographical locations. At step 1004, the list of risks which may affect the entity in specific geographical locations may be displayed on the webpage. The risks may differ from one geographical location to another. At step 1006, the list of risks which may affect the particular entity and sub entity may be displayed on the webpage. The list of risks may be displayed, upon selecting the entity on the webpage. The selection of the entity or the sub entity may be carried out by clicking on the entity on the webpage or some other method. At step 1008, a user associated with the entity can adjust the risk factor for each of the displayed risks. The adjusting of the risk factor may translate to gauging the intensity level of the risk and thereupon assigning a value based on the intensity of the risk. The intensity level of the risk may correspond to the impact which the risk may cause. For example, if it is determined that, the risk may cause high impact, the risk factor may be set as high; alternatively, if it is determined that, the risk may cause low impact, the risk factor may be set as low. The adjustment of the risk factor may be carried out by persons who may have the experience and skill in gauging the intensity of the risk, or by a computer system or application. For example, a weatherman located in the geographical location X is an example of a person to gauge the intensity of the weather events in the geographical location X. Similarly, an economist is an example of a person to gauge the intensity of the risks in the domain of finance. The entity at step 1108 may be provided with an option to adjust the risk factor for risks which may impact the entity. At step 1010, the strategies which may be adopted to overcome the risks may be modified based on the risk factor. The strategies adopted to overcome the risk at different intensities may differ. The strategies adopted to overcome the risks may be directly proportional to the intensity of risk, which may be represented by the risk factor. For example, for dealing with the scenario arising out of a low intensity risk, the strategy adopted may be significantly different from the strategy adopted to deal with the scenario arising out of a high intensity risk.

### EXEMPLARY WEB PAGE DISPLAYING A RISK MAP

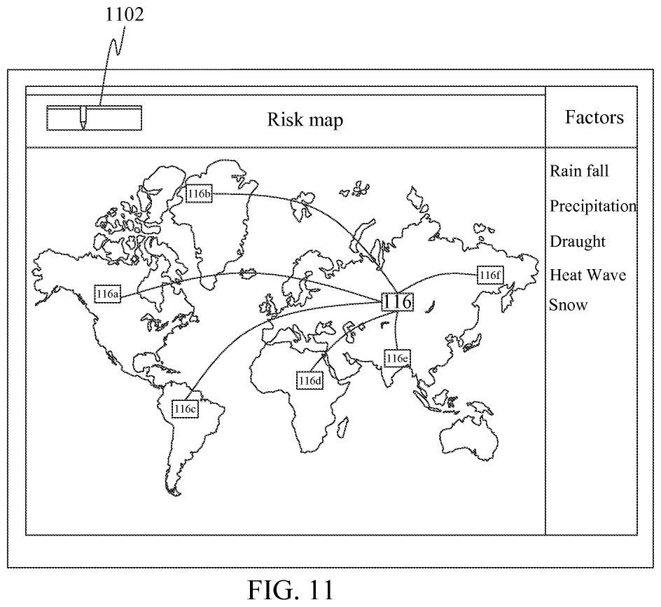

FIG. 11 illustrates an exemplary webpage displaying a risk map, in accordance with an embodiment The webpage may display the map of the geographical regions and may visually display the entity network on the map. The entity network displayed on the map may correspond to one given main entity 116 and its sub entities 116a-116f. Further, the webpage may also display the risks which each of the entities may face. The risks may be displayed, when hovering over, by dicking on, or by otherwise selecting the entity in the webpage or elsewhere in the system. Furthermore, the webpage may also provide an option to the entities to adjust the risk factor. The adjustment of the risk factor may be for example carried out by selecting the entity, selecting the risk and thereupon adjusting the risk probability factor by sliding a slider provided on the webpage. The sliding of the probability slider may translate into a change in the risk factor. Other methods may also be used to adjust the risk factor. For example, a graphical user interface may be provided to the entity to adjust the risk factor.

### EXEMPLARY METHOD FOR OBTAINING OPTIMAL INSURANCE QUOTE

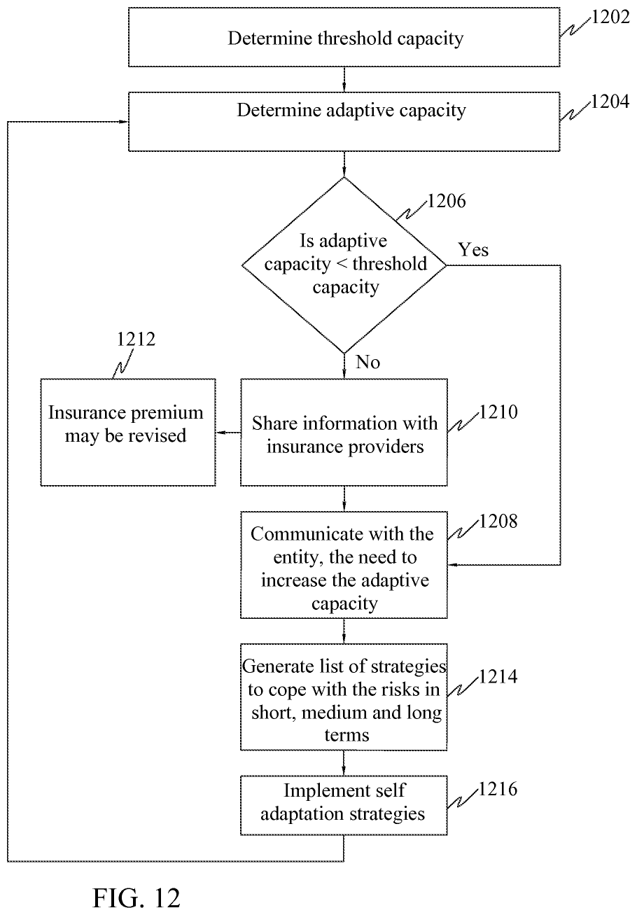

FIG. 12 illustrates an exemplary method for obtaining an optimal insurance premium for the entity, based on the entity's risk management initiatives, in accordance with an embodiment At step 1202, a threshold capacity of the entity may be determined. The threshold capacity of the entity may be defined as the minimum capacity of the entity to cope with risks by adapting. The threshold capacity of the entity can be calculated by considering various parameters including historical records of the entity, past risks and the entity's past ability to adapt and overcome the risks.

The threshold capacity of an entity (or any of its sub-entities) is a numerical value, bounded between two finite values. The numerical value of the threshold capacity may be derived from a number of factors, including historical financial losses, number of days to recovery, number of impacted employees, number of days of loss of production, access to capital (including, but not limited to, loans from financial institutions, governments, and any other third parties), access to insurance among others. The threshold capacity may be defined on a monthly, annual, five-yearly or decadal basis, or any combination thereof.

TL may be defined as the lower end of the threshold capacity, which is also the lower end of the potential impact that the entity or any of its sub-entities is capable of withstanding. The impact may be purely financial in terms of currency amount, or a function of the financial impact. TH may be defined as the higher end of the threshold capacity, which is also the higher end of the potential impact that the entity or any of its sub-entities is capable of withstanding. “Withstanding” here is defined as the ability of the entity or any of its sub-entities to function in a business-as-usual scenario despite certain risk events taking place which may affect the entity.

Together, the set (TL, TH) forms a threshold band. So long as future events risks lie within this band, the entity or any of its sub-entities may be capable of withstanding the event. In case of extreme events he potential impact may cross TH, leading to a scenario that the entity or any of its sub-entities cannot withstand the impact of the events.

At step 1204, an adaptive capacity of the entity may be calculated. Adaptive capacity of an entity may be defined as the instant capability of an entity to cope with crisis arising out of risks.

The adaptive capacity may be defined as the additional capacity that is added to the threshold band such that a new value of the threshold capacity defined by THₚᵣᵢₘₑ is created, wherein THₚᵣᵢₘₑ>TH (the previous value of the higher end of the threshold capacity). The additional capacity available to the entity or any of its sub-entities to define the adaptive capacity may be calculated by considering all the resources available to the entity to adapt to risks, and may be a function of access to capital including, but not limited to, loans from financial institutions, governments, and any other third parties, access to human resources, access to temporary personnel or temporary sub-entities which the entity may call upon, access to sub-entities in a different region that are not exposed to the same risk as another sub-entity under consideration, ability to reduce financial burden including, but not limited to, reduced insurance premiums, financial grants, support from city/state/federal governments, and other forms of support that would enable the entity (or any of its sub-entities) to be better able to withstand a projected risk event.

At step 1206, a check may be carried out to determine if the adaptive capacity is lower than the threshold capacity. If at step 1206, it is determined that, the adaptive capacity of the entity is lesser than the threshold capacity of the entity, then at step 1208, it may be communicated to the entity to increase the entity's adaptive capacity to at least reach the threshold capacity. At step 1214, the entity may be provided with strategies to increase their adaptive capacity. At step 1216, the entity may implement the strategies to increase their adaptive capacity. Thereafter, upon implementing strategies at step 1216, the adaptive capacity of the entity may again be determined at step 1204. However, if at step 1206, it is determined that, the adaptive capacity is equal to or greater than the threshold capacity, the information may be shared with insurance providers of the entity at step 1210. At step 1212, the insurance providers may provide an insurance quote to the entity, depending on the capacity of the entity to cope with risks.

### EXAMPLE

An exemplary entity is involved in the business of manufacturing textiles. The entity may have incorporated the system 100 to determine the risks that they may face and thereafter suggest strategies. The entity in the business of manufacturing textiles, may depend on various sub entities for manufacturing textiles. For example, they would need cotton, manufacturing facilities, machinery to manufacture textiles, employees and transportation to transport raw materials, among other needs. The entity may have manufacturing facilities in different geographical locations. The entity may procure raw materials in different geographical locations. The raw material required for an entity involved in the business of textiles may be cotton. Cotton may be supplied to the entity by various sub-entities who grow cotton. The growth of cotton depends on natural elements such as rain among other natural phenomenon. The yield of cotton may depend on the amount of precipitation available to the crop. Too much of precipitation may damage the crops, too little precipitation may lower the yield. Hence the amount of precipitation available to the crop may determine the yield of the crop. The yield of the crop will have an impact on the risks faced by the entity. The strategies adopted by the entity to overcome risks due to crop yield may depend on the yield of the crop. If it is determined that, there may be low yield due to floods or drought, the entity may have to adopt a strategy to procure cotton from alternate sources. On the contrary, if it is determined that, the crop yield is high, then it may lead to lowering of prices of cotton leading to reduces cost for to the entity. In such scenarios, the risk faced by the entity in this regard is reduced. Each different supplier or unit which may not be the main entity can be considered as a sub entity of the main entity. The business of the main entity depends on all the sub entities as well as the main entity. The risks which the main entity as well as the sub- entities face, will ultimately have an impact on the business of the main entity. The system will identify all the risks faced by the main entity as well as the sub entities. The risks faced by the entities may be from factors such as weather, climate, political and economic factors, among other factors. The system will alert the entity about impending risks and also provide strategies to overcome the risks. The system may provide various strategies and the entity may use the strategy best suited for their needs. The system may also display the entity network on webpage, wherein the entity network may be displayed on a map.

### CONCLUSION

In light of the above disclosure, it is evident that, the present invention has many advantages over existing technologies. Some of those advantages are mentioned below:

The system enables identification of risks faced not just by the main entity, but also the sub entities associated with the main entity.

The system identifies risks faced by the entity by considering various factors which go beyond factors such as weather and climate.

The system can predict risks well into the future. For example, the system can predict risks 10 years into the future, particularly in the case of climate.

The system sends alerts to the entities informing them about the risks faced by them.

The system automatically provides strategies to overcome risks faced by the entities

The system enables the entity to adjust the factor of risk and provides modified strategies based on the adjusted risk factor.

The processes described above is described as sequence of steps, but this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many examples, and these should not be construed as limiting the scope of the invention but as merely providing illustrations of some of the embodiments of this invention. Thus the scope of the invention should be determined by the appended claims and their legal equivalents rather than by the examples given.

What is claimed is:

1. A system to identify risks and provide strategies to overcome risks, wherein the system is configured to:
accumulate information corresponding to an entity and at least one sub-entity that operates in association with the entity:
identify a plurality of risks having an impact on the functioning of the entity, by processing at least a portion of the information accumulated;
generate and communicate alerts to the entity specifying the risk; and
provide strategies to the entity to overcome impacts of the risks faced by the entity.

2. The system according to claim 1, wherein the risks faced by the entity are based on one or more of weather data, climate data, political data, economic data, historical records, entity internal data, real-time data and forecast references.

3. The system according to claim 1, wherein the system is configured to list the risks faced the entity and enable storing of a list of risks in a database.

4. The system according to claim 1, wherein the system is configured to enable modification of the risks and update risks critical to the operations of the entity.

5. The system according to claim 1, wherein the system is configured to determine risks which are critical to the operations of the entity, wherein the critical risks have a higher negative impact on the operations of the entity compared to risks that are not considered critical.

6. The system according to claim 1, wherein the system is configured to prioritize risks based on their criticality to the operations of the entity.

7. The system according to claim 1, wherein the system is configured to access if the entity is facing one or more risks by processing the information corresponding to the entity, the at least one sub-entity, and the identified plurality of risks.

8. The system according to claim 7, wherein the system is configured to project risks faced by the entity for a future time frame, based on learning obtained by processing data pertaining to historical climate models and events.

9. The system according to claim 1, wherein the strategies to overcome risks faced by the entity are based on one or more of historical strategies adopted in a geographical location, historical strategies adopted in an industry, and historical strategies adopted by the entity.

10. The system according to claim 9, wherein the system is configured to correlate strategies to the risks faced by the entity.

11. The system according to claim 1, wherein the system is configured to enable adjustment of a factor of risk for each of the risks faced by the entity.

12. The system according to claim 11, wherein the strategies adopted to overcome the risk is proportional to the factor of risk.

13. The system according to claim 1, wherein the system is configured to enable the entity to modify the strategy provided by the system to overcome the risk.

14. The system according to claim 1, comprises pre-configured logic to enable the system to identify risks and provide strategies to overcome risks, wherein the logic is based on one or more of operating procedures and business decisions of the entity, and climate parameters affecting the entity.

15. The system according to claim 1, wherein a risk score is determined by the system by adding parameters affecting the entity and thereby determining a quantum of risk affecting the entity.

16. A system to identify risks and provide strategies to overcome risks, the system comprising:
a critical risk determination module configured to determine risks which are critical to the operations of the entity and have a higher negative impact on the operations of the entity compared to risks that are not considered critical;
a risk assessment module configured to:
receive information corresponding to at least one entity and at least one or more sub-entities that operate in association with the entity; and
identify a plurality of risks that are inferred to have an impact on the performance of the entity, by processing at least a portion of information received;
an alerting module configured to generate alerts specifying the risks faced by the entity or sub-entity by processing at least a portion of the information received by the risk assessment module;
a strategy module configured to:
generate strategies to overcome risks faced by the entity; and
correlate strategies to the risks faced by the entity.

17. The system according to claim 16, the system further comprising:
a database comprising one or more of data pertaining to entities and its sub entities, list of risks affecting the entity and its sub entities, historical data pertaining to risks faced by the entity, listing of strategies adopted to overcome corresponding risks, historic data pertaining to strategies adopted as per geographical location to overcome risks, historical data pertaining to strategies adopted by a specific industry to overcome risks, historical data pertaining to strategies adopted by a specific entity to overcome risks, historic weather data, weather forecast data, climate forecast data, political reporting data, economic reporting data and entity internal status report data; and
a risk factor adjustment module configured to enable adjustment of a factor of risk of the risk faced by the entity.

18. A method for obtaining an insurance premium for an entity, the method comprising:
determining a lower threshold capacity of the entity;
determining a higher threshold capacity of the entity;
determining if a risk is within the lower threshold capacity and the higher threshold capacity;
determining an adaptive capacity of the entity; and
sharing the adaptive capacity, the lower threshold capacity and the higher threshold capacity to obtain an insurance premium for the entity.
